(19) United States
(12) Patent Application Publication
(10) Pub. No.: US 2023/0094793 A1
(43) Pub. Date: Mar. 30, 2023

(54) Video Input Connector

(71) Applicant: Explorer Surgical Corp., Louisville, CO (US)

(72) Inventors: Jennifer Porter FRIED, Chicago, IL (US); Eugene Aaron FINE, Northbrook, IL (US); Joseph BINTER, Batavia, IL (US); Rob STINEMAN, Chicago, IL (US); Marion MULLER, Chicago, IL (US)

(73) Assignee: Explorer Surgical Corp., Louisville, CO (US)

(21) Appl. No.: 17/676,446

(22) Filed: Feb. 21, 2022

Related U.S. Application Data
(60) Provisional application No. 63/248,602, filed on Sep. 27, 2021.

(51) Int. Cl. H04N 7/10; H04N 5/46; G06F 13/38

(52) U.S. Cl. CPC H04N 7/104; H04N 5/46; G06F 13/385

(57) ABSTRACT

The system may provide a one-stop-shop solution for accepting and integrating with almost any video output from a medical device that is typically used in a healthcare facility and sending the video signal to a streaming platform. The system may be configured as a box with a plurality of different types of video input ports, an output port configured for interfacing with an input port of a video streaming device and a port selector configured to indicate which of the input ports is providing video signals to the output port.

### CROSS-REFERENCE TO RELATED APPLICATIONS

This application claims priority to and the benefit of U.S. Provisional Application Ser. No. 63/248,602 filed Sep. 27, 2021 and entitled “Video Connector,” which is incorporated herein by reference in its entirety for all purposes.

### FIELD

This disclosure generally relates to video connectors, and more particularly, to a box that provides pre-set connections for different types of video inputs to be output via a USB port to a streaming portal.

### BACKGROUND

In the light of the COVID-19 pandemic and technology advancements, remote technology has been steadily introduced to the medical procedure suite to help facilitate remote case support, proctoring, training, observation, and data collection experiences. This is especially important as innovative medical supply companies often introduce medical devices (e.g., medical equipment, monitoring devices, therapies, software, apps, implants, and platforms) into the medical procedure suite. These medical supply companies have a strong need to properly train physicians on the medical devices in order for the physicians to fully adopt and integrate the medical devices for use when treating patients. However, it is often incredibly difficult to ensure that the necessary people are physically in the procedure suite during different training sessions, largely due to travel inconveniences (further exacerbated by the pandemic), health concerns and other safety concerns.

Remote technology has often filled the gap in training and case support to allow people all over the world to perform their jobs remotely, instead of standing side-by-side with the physician in an operating room, as was the practice in the past. However, for remote technology to be optimally leveraged, important data about the medical devices and the video signals should be streamed directly for the remote participant to see as clearly as if she were standing in the room. The medical devices used during the procedures may include, for example, fluoroscopy /c-arms, echo/ultrasound, hemodynamics/patient vitals, endoscopes, microscopes, and proprietary technology platforms developed by different medical device companies.

Most of these medical devices contains video outputs, wherein the video outputs interface with a video streaming platform in order to stream the live video from the medical devices. The medical devices may include a variety of types of video outputs, so there could be dozens of procedures, mechanisms, cables and connectors for connecting to the diverse types of video outputs from the medical devices. The most common video outputs from medical devices are DisplayPort, HDMI, DVI, VGA, BNC, SDI, and S-Video. In order to provide a medical device company or hospital team with the correct equipment for integrating a video streaming platform with the medical devices, very specific questions must be answered at least a week prior to interfacing the medical device with the streaming platform. Some exemplary questions may include, for example: What specific medical equipment do you want to integrate with the remote platform, so you can see the video remotely? What video outputs exist on that specific medical equipment, and are the video outputs already being used? What monitors does this medical equipment already feed into? What video outputs exist on these monitors? What recording devices does the medical equipment already feed into? What video outputs exist on those recording devices? Can you provide pictures of the video outputs available on all of the medical equipment listed above?

Answering these questions is often cumbersome for medical device companies and hospital staff. They are already so busy with their day job, such that adding one more task to their plate may be the difference between successfully executing a remote case experience versus not being able to incorporate the remote technology. As such, a need exists for a better, more streamlined solution that can be truly plug-and-play, in order for the remote technology to be adopted in medical procedure suites more broadly. A need also exists for improving the process of connecting those video outputs to the video streaming platform by creating a connection process that is seamless, easy, and streamlined for someone completely new to remote technology. A need also exists for a plug-and-play solution that allows remote technology to be truly adopted broadly in medical procedure suites around the world.

### SUMMARY

In various embodiments, the video connector may comprise a plurality of video input ports, wherein at least some of the plurality of video input ports are of different types, and wherein each of the plurality of video input ports is configured for interfacing with a video output port of a device; a video output port configured for interfacing with a video input port of a video streaming device; and a port selector configured to indicate one or more of the plurality of video input ports that is providing video signals to the video output port.

The video input ports may include at least one of a DisplayPort, HDMI, DVI, VGA, BNC, SDI or S-Video. One or more of the plurality of video input ports may interface with the video output port of the device via at least one of a cable or a wireless interface. The video output port may interface with the video input port of the video streaming device via at least one of a cable or a wireless interface. The video streaming device may include a video streaming platform. The one or more of the plurality of video input ports may include a splitter that is configured to split a video signal from the device such that a first portion of the video signal is transmitted to the video output port and a second portion of the video signal is transmitted back to an auxiliary device.

The system may also include a selector configured to receive (e.g., from a remote control) a selection of one or more of the plurality of video input ports to be active. The selector may be configured to automatically detect one or more of the plurality of video input ports that is active. The selector may be configured to automatically detect one or more of the plurality of video input ports that is active based on polling of the plurality of video input ports. The selector may be configured to provide a notification of the one or more of the plurality of video input ports that is providing video signals to the video output port. The selector may be configured to provide an audio signal of the one or more of the plurality of video input ports that is providing video signals to the video output port.

The system may also include a switching mechanism that at least one of determines or receives data about one or more of the plurality of video input ports that is providing video signals to the video output port, wherein the switching mechanism is configured to assign one or more component to a pathway between the one or more of the plurality of video input ports and the video output port. A pathway may exist between one or more of the plurality of video input ports and the video output port, wherein the pathway includes one or more decoders, scalers, converters, splitters or switches.

In various embodiments, a method may comprise receiving, by one of a plurality of video input ports, a connection of a video output port of a medical device to the one of a plurality of video input ports, wherein at least some of the plurality of video input ports are of different types, and wherein each of the plurality of video input ports is configured for interfacing with a video output port of the medical device; detecting, by a port selector, one or more of the plurality of video input ports that is receiving video signals; activating, by the port selector, a display corresponding to the one or more of the plurality of video input ports that is receiving video signals; receiving, by a video output port, the video signals; receiving, by the video output port, a connection to a video input port of a video streaming device; and receiving, by the video input port of the video streaming device, the video signals from the video output port.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a first view of an example video connector showing the port selector lights and video output port, according to various embodiments.

FIG. 2 is a second view of the example video connector shown in FIG. 1 showing the various types of video inputs, according to various embodiments.

FIG. 3 shows a schematic diagram of an exemplary electrical system architecture for a PCBA Layer 1, according to various embodiments.

FIG. 4 shows a schematic diagram of an exemplary electrical system architecture for a PCBA Layer 2, according to various embodiments.

FIG. 5 shows a schematic diagram of an exemplary electrical system architecture for a PCBA Layer 3, according to various embodiments.

### DETAILED DESCRIPTION

In various embodiments, the system provides an improvement over existing technology and processes because the system may be a one-stop-shop solution for accepting and integrating with almost any video output from a medical device that is typically used in a healthcare facility and transmitting the video signal to a streaming platform. In various embodiments, the system may be described in conjunction with a box, but the system may include any device and/or software for supporting, aggregating and/or interfacing various electrical components. For example, the system may include a board, printed circuit board (PCB), printed circuit board assembly (PCBA), a component rack or a box.

The box may be a light-weight box, for example, weighing less than four pounds. The box may include various types of video input ports and one or more video output port. The box may also include one or more port selectors and one or more displays. The system may include any configuration for the various integration options that could be used to connect with video input ports, a video output port and/or a port selector. The video input ports, video output port and/or selector display may be located anywhere on and/or inside the box. The video input ports, the output port and/or selector display may be located remote from the box and interface with the box by a cable and/or wireless interface. The box is easily maneuverable in the procedure suite. The box may eliminate or reduce the need for significant pre-case planning and may give users the confidence to integrate with any video imaging device in a matter of seconds upon setting up for the procedure.

As used herein, while the disclosure may include transmissions via cable through a physical port, any portion of the transmission of video (or other data) may be through a cable connection, wireless interface with a receiver and/or any combination thereof. For example, the system may incorporate a Bluetooth® or other wireless protocols to wirelessly transmit data (e.g., video signals). In that regard, the term “port” may be used interchangeably with “interface”. Such wired or wireless transmissions may be from the medical device to the box, from the medical device to an auxiliary device, from the box to an auxiliary device, among components within the box and/or from the box to the streaming portal.

As used herein, the phrases “output port” and “input port” may be relative and used interchangeably. The phrase may describe the direction of the video signals. For example, the medical device may have an output port that sends the video signal out to the box. The box may include input ports that receive the video signal from the medical device. The box may also have output ports that send the video signal out to an input port of the video streaming platform. The streaming platform may stream the live video (e.g., over 4G LTE) to viewers outside of the hospital.

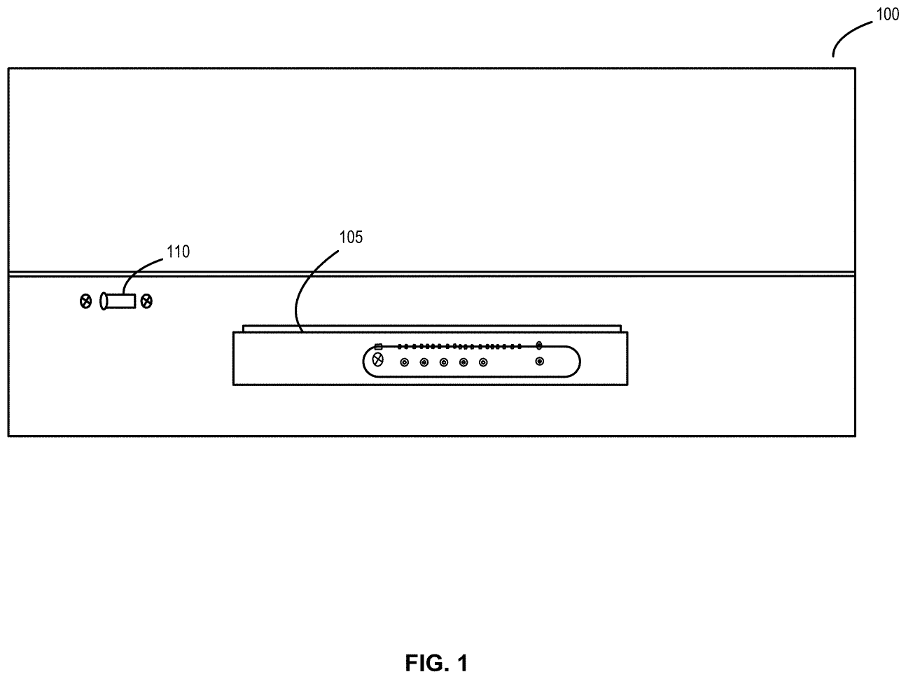

In various embodiments, the video input ports may be located anywhere on the box. For example, the video input ports may be located on one side of the box (e.g., on the back of the box). As shown in FIG. 1, the most common video formats and/or video input ports may include, for example, one or more of a DisplayPort 215, HDMI 205, DVI 260, VGA 220, BNC 230, SDI 250, and/or S-Video 240.

In various embodiments, the system may be described in conjunction with medical devices and healthcare facilities. However, the system may also be used in any facility or with any type of products that provide output signals. For example, the system may be used in a school facility that has many types of audio/visual devices with different output ports that may need to interface with a common input port.

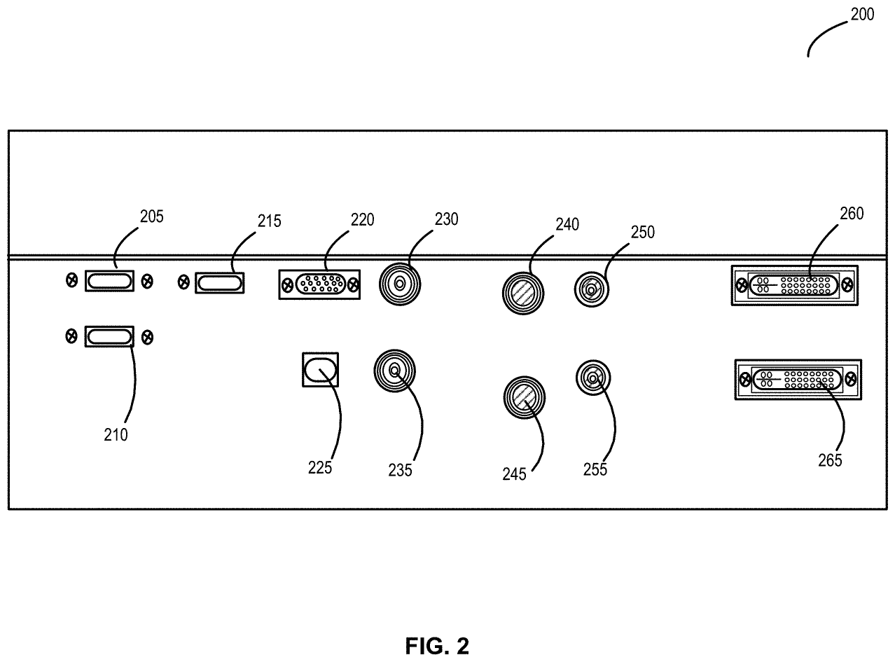

A user can simply plug into one or more of the video input ports on the box depending on the video output found on the medical device in the medical procedure suite. The box may interface with video output ports on the medical equipment and/or an auxiliary device (e.g., monitor) that the medical equipment is already connected to. However, these video outputs from the medical devices may very well be “taken” as the medical device may be plugged into larger monitors for clinicians to see in the room, thus additional equipment may need to be provided in order to split the video signal from the medical device. The ability to split the signal may allow the medical device to have cables still being connected to both the box and the large room monitors. If the video output from the medical device needs to interface with an auxiliary device in the procedure suite or elsewhere, the system may include an active pass-through or loop back. As shown in FIG. 2, in various embodiments, the box may include an extra video port (HDMI 210, BNC 235, S-Video 245, SDI 255, DVI-1 265), such that the video signal from the medical device may be transmitted into the main video input port (205, 230, 240, 250, 260) in the box, then the box may split the video signal. The first portion of the split video signal may then be transmitted back out of the box through the extra video port (210, 235, 245, 255, 265), through a cable and into the auxiliary device within the medical procedure suite (e.g., internal monitor). The second portion of the split video signal may also be transmitted out of the box through the USB Out interface 110 (e.g., USB 3.0) to the video streaming platform. In various embodiments, any of the video input ports may include one or more extra video ports to facilitate splitting the video signal to one or more other ports. In various embodiments, the system may also include a VGA BNC/S-Video switch. The electronics in the box may be coupled to a hardware component that takes in all multiple video inputs and converts the video inputs. As such, the VGA BNC/S-Video switch may be used to select which input needs to be converted.

In various embodiments, the user may select which video input port may be in use. For example, the user may use an app, a remote control or a selection button (e.g., on the box) to select the video input port. In various embodiments, the box may auto-detect the video input port in use, in response to the video input port receiving a signal or being connected to a cable. In particular, the system may conduct “round robin” electronic polling of each of (or a subset of) the video input ports. In response to detecting current at the video input port, the system may determine that the particular video input port is live or active. The system may detect the current by having one or more wires from the selector to each output port. The selection or detection of the video input port may trigger the box to transmit the live video feed from the particular detected video input port to the video output port, then to the video streaming platform. In various embodiments, when the system is trying to determine the active and inactive ports, the system may determine the video input ports that are not in use based on a lack of current from the video input ports, and then determine that the remaining port is the active port.

As shown in FIG. 1, the box may include a port selector with a “menu” 105 (e.g., on the front of the box), wherein the menu lights up a certain light depending on which video input port is currently in use. Each light may correspond to a particular video input port (and include a label of a different video input port above each light). The system may also include an audio signal or voice signal to announce the video input port in use. The system may also send a notification about the video input port in use to an audio/visual system management device, building management device, hospital management device, educational system, scheduling system, calendaring system, app, website, social media or any other recipient. Similar to above, in response to detecting current at the video input port, the system may determine that the particular video input port is live or active, and light up the appropriate indicator light or send a signal about the video input port in use.

In various embodiments, the box (e.g., on the front of the box) may also include a video output port or interface (e.g., USB connection) to interface with the video streaming platform which is used to stream the live video (sent from the medical device to the video input port) to the remote audience. The video streaming platform may include one or more of a video streaming device, app, software, hardware, internet connection, etc. For example, the medical devices in a medical procedural suite may be integrated with video streaming platforms that include a Microsoft Surface Go 2TM Tablet that includes the Explorer LiveTM system from Explorer Surgical of Chicago, Ill.

After the video signals enter the video input port on the box, the video signal and/or the transmission channel may need to be converted or changed to allow the video signal to exit from the USB output port 110. In this regard, the system may incorporate various components (e.g., video capture cards, converters, and associated cables) within pathways in the box between the video input port(s) and the video output port 110. Such components may also be plugged into a laptop or tablet such as, for example, a Microsoft SurfaceTM. The pathway between each video input port and the video output port may also include separate components (e.g., components that are dedicated to, and only used for, a particular pathway). However, in various embodiments, the system may share certain components among different pathways. The system may share components by, for example, using a switching mechanism. The switching mechanism may determine or receive data about the live feed (e.g., based on the detecting of the current in the video input port, as discussed above), then the switching mechanism may assign the component to the pathway that includes the live feed.

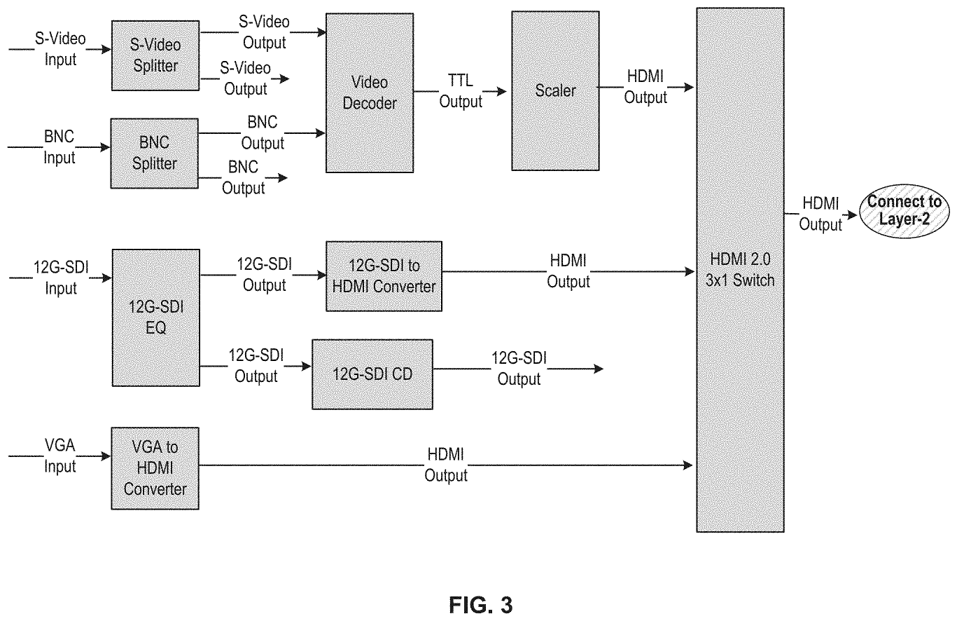

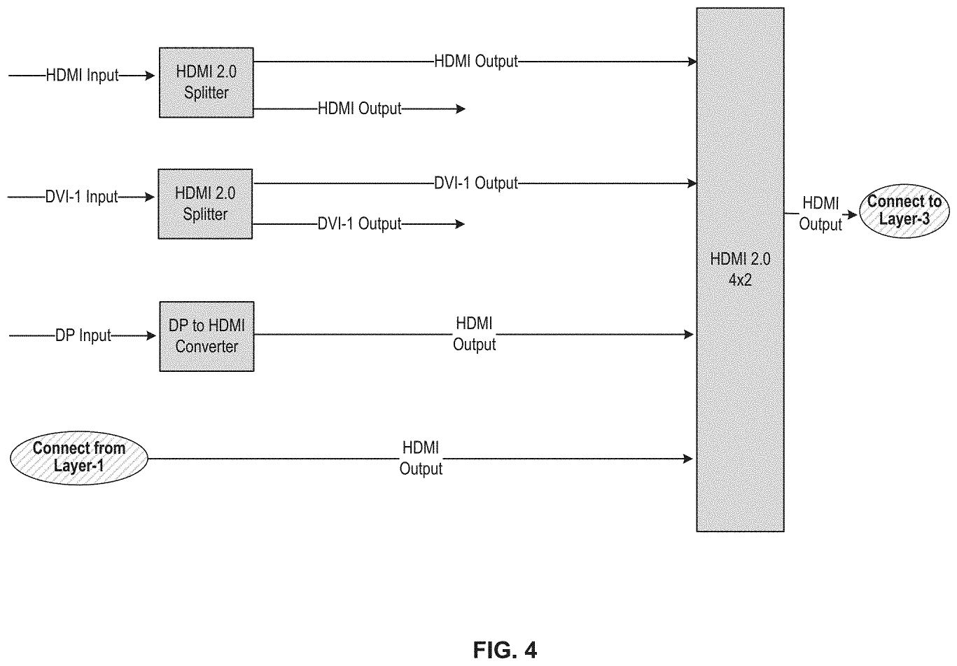

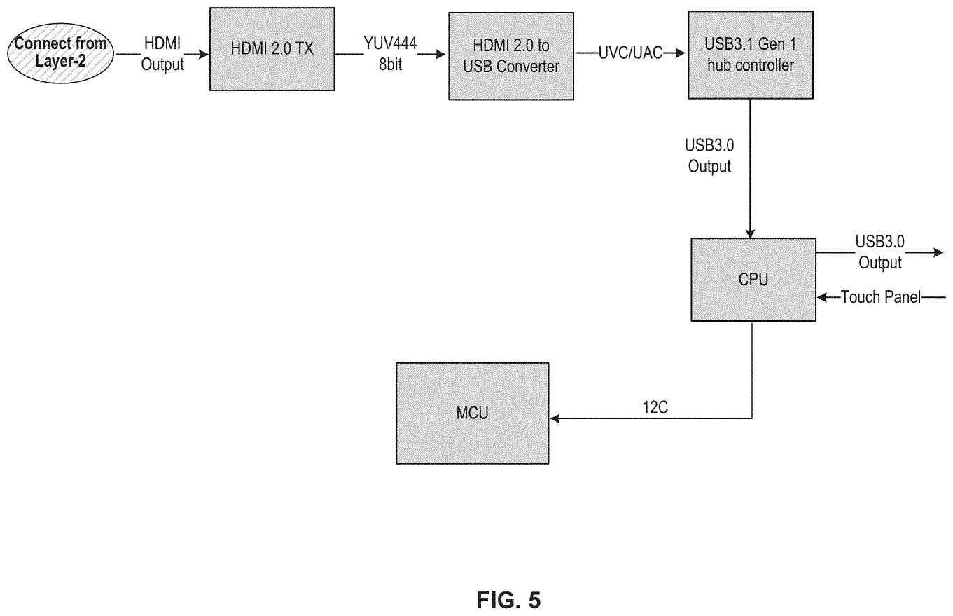

In various embodiments, the system may provide one or more of numerous options to a medical procedure suite in order to successfully integrate a video streaming platform with medical equipment. The system may include various components in the pathway between the video output port and the USB output port in order to appropriately manage the video signal and pathway. In various embodiments, and as shown in FIGS. 3-5, the video input ports may lead to pathways with components that are grouped and distributed among various PCBA layers. For example, as shown in FIG. 3, PCBA Layer 1 may include VGA IN, BNC (CVBS) IN, BNC (CVBS) OUT, SV IN, SV OUT, 12G SDI IN, 12G SDI OUT, 24V DC IN. As shown in FIG. 4, PCBA Layer 2 may include DisplayPort (DP) IN, DVI IN, DVI OUT, HDMI IN, HDMI OUT. As shown in FIG. 5, PCBA Layer 3 may include Qualcomm SOM and USB 3.0 OUT.

To determine the optimal type, model and configuration of components in the pathway, the system may consider factors such as, for example, video formats, frames, recognizing camera, cost, minimization of the degradation of quality of the video, resolution (e.g., medical quality resolution), physical interfaces (e.g., number of interfaces, type of interfaces, etc), power requirements, compatibility, noise, availability, source of component (e.g., cannot send Taiwan sub-components to China due to customs), minimizing the number of components, etc. Based on at least the above factors, the system may include the below pathway configuration options all in one box, or any subset of configuration options in one box.

1. BNC Analog: Device >SDI/BNC Cable >BNC to HDMI Converter >HDMI Cable >HDMI to USB Video Capture Card (which may be the same as the USB OUT port)>USB Cable >Surface

2. SDI Digital: Device >SDI/BNC Cable >SDI to USB Video Capture Card >USB Cable >Surface

3. HDMI: Device >HDMI Cable >HDMI to USB Video Capture Card >USB Cable >Surface

4. (the DVI input may receive DVI-D and/or DVI-I cables) DVI-D: Device >DVI to HDMI Cable >HDMI to USB Video Capture Card >USB Cable >Surface

5. DVI-I: Device >DVI to HDMI Cable >HDMI to USB Video Capture Card >USB Cable >Surface

6. DisplayPort: Device >DisplayPort to HDMI Cable >HDMI to USB Video Capture Card >USB Cable >Surface

7. S-Video: Device >S-Video Cable >S-Video to HDMI Converter >HDMI Cable >HDMI to USB Video Capture Card >USB Cable >Surface

8. VGA: Device >VGA Cable >VGA to HDMI Converter >HDMI Cable >HDMI to USB Video Capture Card >USB Cable >Surface

9. BNC Analog Split: Device >SDI/BNC Input on Powered Splitter (plugged into outlet)>SDI/BNC Out to Device >SDI/BNC Out >BNC to HDMI Converter >HDMI Cable >HDMI to USB Video Capture Card >USB Cable >Surface

10. SDI Digital Split: Device >SDI/BNC Input on Powered Splitter (plugged into outlet)>SDI/BNC Out to Device >SDI/BNC Out >BNC to HDMI Converter >HDMI Cable >HDMI to USB Video Capture Card >USB Cable >Surface

11. HDMI Split: Device >HDMI Input on Powered Splitter (plugged into outlet)>HDMI Out 2 to Device >HDMI Out 1 to HDMI >HDMI to USB Video Capture Card >USB Cable >Surface

12. DVI-D Split: Device >DVI Input on Powered Splitter (plugged into outlet)>DVI Out 2 to Device >DVI Out 1 to HDMI >HDMI to USB Video Capture Card >USB Cable >Surface

13. DVI-I Split: Device >DVI Input on Powered Splitter (plugged into outlet)>DVI Out 2 to Device >DVI Out 1 to HDMI >HDMI to USB Video Capture Card >USB Cable >Surface

14. S-Video Split: Device >S-Video (Male) into Device >S-Video (Female1) to original S-Video connection >S-Video (Female2) - S-Video Cable to HDMI >S-Video to HDMI Converter >HDMI Cable >HDMI to USB Video Capture Card >USB Cable >Surface

15. VGA Split: Device >VGA Input on Powered Splitter (plugged into outlet)>VGA Out to Device >VGA Out to VGA >VGA to HDMI Converter >HDMI Cable >HDMI to USB Video Capture Card >USB Cable >Surface

The above configurations may include the below exemplary components. The video streaming platform may include any tablet, laptop, smartphone or other computing device. For example, the video streaming device may include a Microsoft Surface Go 2TM Tablet. The capture card may include, for example, the Inogeni capture card (HDMI to USB 3.0 Video Capture Card, 4K Video Resolution Support). The USB 3 to USB-C convertor may include, for example, Amazon Basics USB Type-C to USB 3.1 Genl Female Adapter—Black. The DisplayPort to HDMI may include, for example, Benfei DisplayPort to HDMI Male to Male Adapter Gold-Plated Cord. The HDMI to HDMI cable may include, for example, Amazon Basics High-Speed HDMI Cable (18 Gbps, 4K/60 Hz). The powered HDMI splitter may include, for example, OREI HDMI Splitter 1 in 2 Out 4K - 1×2 HDMI Display Duplicate/Mirror -Powered Splitter Full HD 1080P, 4K @ 30 Hz (One Input To Two Outputs). The DVI to HDMI cable may include, for example, HDMI to DVI Cable 3 Feet Bi-Directional Nylon Braid Support 1080P Full DVI-D Male to HDMI Male High Speed Adapter Cable Gold Plated for PS4, PS3 HDMI Male A to DVI-D. The powered DVI splitter may include, for example, DVI Splitter 1 in 2 Out 2 Port DVI Dual Monitors Distribution Duplicator Video Splitter (EDID Management) Support Resolution up to 4K2K/30HZ for PC Laptop DVR Projector HDTV. The DVI to DVI cable may include, for example, Rankie DVI to DVI Cable. The BNC to HDMI Video Capture Card may include, for example, BNC to HDMI Converter Adapter Female CVBS BNC HDMI Coax Connector Coaxial Composite Analog Video Audio Input 1080P Output HDCP Hook Security Camera DVRs Surveillance CVR AC1420 CCTV for Monitor HD TV. The BNC/SDI Cable may include, for example, Monoprice HD-SDI RG6 BNC Cable - 3 Feet - Black for Use in HD-Serial Digital Video Transfer, Mobile Apps, HDTV Upgrades, Broadband Facilities -Viper Series. The Powered BNC Video Analog Splitter may include, for example, AuviPal 4-Port (1 Input 4 Output) BNC Video Splitter Box Coaxial Distributor Amplifier for Video Monitoring System CCTV Security Camera. The SDI Digital Capture Card may include, for example, FERRISA Micro Converter SDI to HDMI(with Power Supply), 3G-SDI/HD-SDI/SD-SDI to HDMI Converter Adapter, SDI in HDMI out SDI Loopout,1080P Video Audio Splitter, Support HDCP 1.3 for Camcorder Camera to TV. The Powered SDI Digital Splitter may include, for example, J-Tech Digital Premium Quality SDI Splitter 1x2 Supports SD-SDI, HD-SDI, 3G-SDI up to 1320 Ft (1 Input and 2 outputs). The VGA to HDMI Capture Card may include, for example, VGA to HDMI, GANA 1080P Full HD Mini VGA to HDMI Audio Video Converter Adapter Box with USB Cable and 3.5 mm Audio Port Cable Support HDTV for PC Laptop Display Computer Mac Projector. The VGA to VGA may include, for example, Pasow VGA to VGA Monitor Cable HD15 Male to Male for TV Computer Projector. The VGA Powered Splitter may include, for example, KELIIYO VGA Splitter 2 Port Powered Video Splitter with AC Adaptor 1 to 2 VGA Duplicator Support 1920X1440 Resolution 220 MHz Bandwidth for Screen Duplication. The S-Video to HDMI Capture Card may include, for example, Tensun 3RCA AV CVBS Composite & S-Video R/L Audio to HDMI Converter Adapter Support 720P/1080P for PS2 PS3 NES SNES Nintendo 64 HDTV. The S-Video to S-Video Cable may include, for example, Cmple - S-Video Cable Gold-Plated (SVHS) 4-PIN SVideo Cord. The S-Video Non-Powered Splitter may include, for example, zdyCGTime S-Video 4 Pin Mini DIN Y Splitter Connector Cable 4 Pin Mini DIN S-Video Male to 2 Female Y Splitter Extension Adapter Cable for SVHS/S-Video Cable(28CM/11Inch).

In various embodiments, the box may include an integral display. For example, a Windows® iPad or Tablet may be integrated directly into the box. The display may be built into one of the sides of the box, with an internal processor and storage device that is configured to run one or more applications, such as Explorer LiveTM. The tablet may also include the box (with various internal pathways) integral with the tablet such that the various video input ports may be included on the top, side and/or bottom of the tablet. For example, the tablet may include a Flytech K755 Android tablet that may be customized to include the various ports discussed herein. The tablet may include, for example, one or more of a Qualcomm SnapDragon 660 processor, 4 GB DDR4 of RAM Memory, 64 GB eMIVIC flash storage, the Android 10 operating system, IEEE 802.11 WiFi, 35-65 W power supply and PCAP multi-touch. The tablet may include 12 video i/o ports. The i/o ports may be arranged in two rows. In various embodiments, the display may be approximately five inches in size. In various embodiments, the system may be embodied as any type of computation or computer device, such as similar to a laptop computer, notebook computer, a tablet computer, and/or a mobile computing device. This may eliminate or reduce the need for a separate computing device (e.g., a notebook computer running the Explorer LiveTM) in the operating room.

The box may be used by healthcare facilities without healthcare professionals needing to figure out the type of connections needed or answering any of the qualifying questions. The box is a plug-and-play solution that can be adapted to any procedure suite environment and can be set-up in a matter of seconds, after being delivered to the procedure suite. This reduces the time needed to prepare for a remote case experience, which in turns gives more physicians (and other healthcare professionals) more access to remote procedural expertise, thereby allowing the physicians to accelerate case volumes and treat more patients upon receiving the proper training.

The system may include or be packaged with the Explorer Live™ software platform. The software platform may be configured for remote proctoring, training, case observation, and support from medical device companies. These medical device companies are most likely launching new products and/or training new physicians on the use of their products, so that the medical device companies can provide access to their therapies and innovations to more hospitals and more patients

The individual users of the system may include, for example, medical device representatives who support cases locally in their respective hospitals and regions. These people are oftentimes responsible for setting up the medical procedure suite so that a remote proctor, product expert, trainee, etc. can observe or support the case remotely. Moreover, hospital staff (e.g., nurses, scrub techs, physician assistants, etc.) may use the system because the staff are oftentimes responsible for setting up the medical procedure suite, if nobody from the medical device company is available to support the case in-person.

The users of the system may benefit during the days/weeks leading up to a medical procedure. For example, with the confidence in having the video connector box, there is no need to take time to answer the video streaming platform representative's questions. Answering those questions tends to involve extra trips to the procedure suite, taking pictures of every piece of equipment in the room, and sometimes even getting on your hands and knees to obtain the necessary information. Embodiments of this disclosure remove or minimize the need for all of this pre-work, since the system contains various integration chain options that may be needed.

During set-up on the day of the procedure, users may not have to troubleshoot multiple different integration chains, plug multiple pieces of small equipment into each other, and ultimately connect everything together for the proper streaming. Using this system, all of these pathways are pre-configured in a pre-built box, so that the user does not even need to see or know the intricacies involved in ensuring the proper connection. In a matter of seconds, the user may identify the video output and connect to the proper video output port on the box.

The disclosed embodiments may be implemented, in some cases, in hardware, firmware, software, an app, social media or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

The features and elements discussed herein may be combined in various combinations without exclusivity, unless expressly indicated herein otherwise. These features and elements as well as the operation of the disclosed embodiments will become more apparent in light of the following description and the accompanying figures. The detailed description of various embodiments herein refers to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Any reference to attached, fixed, connected or the like may include permanent, removable, temporary, partial, full and/or any other possible attachment option. Additionally, any reference to without contact (or similar phrases) may also include reduced contact or minimal contact.

The scope of the disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. All ranges and ratio limits disclosed herein may be combined.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic.

Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

1. A video connector comprising:
a plurality of video input ports, wherein at least some of the plurality of video input ports are of different types, and wherein each of the plurality of video input ports is configured for interfacing with an output port of a device;
a video output port configured for interfacing with a video input port of a video streaming device; and
a port selector configured to indicate one or more of the plurality of video input ports that is providing video signals to the video output port.

2. The system of claim 1, wherein the plurality of video input ports include at least one of a DisplayPort, HDMI, DVI, VGA, BNC, SDI or S-Video.

3. The system of claim 1, wherein one or more of the plurality of video input ports interface with the video output port of a device via at least one of a cable or a wireless interface.

4. The system of claim 1, wherein the video output port interfaces with the video input port of the video streaming device via at least one of a cable or a wireless interface.

5. The system of claim 1, wherein the video streaming device includes at least one of a video streaming platform or a video streaming app.

6. The system of claim 1, wherein one or more of the plurality of video input ports interfaces with a splitter that is configured to split a video signal from the device such that a first portion of the video signal is transmitted to the video output port and a second portion of the video signal is transmitted back to an auxiliary device.

7. The system of claim 1, wherein the port selector is configured to receive a selection of one or more of the plurality of video input ports to be active.

8. The system of claim 1, wherein the port selector is configured to receive from a remote control a selection of one or more of the plurality of video input ports to be active.

9. The system of claim 1, wherein the port selector is configured to automatically detect one or more of the plurality of video input ports that is active.

10. The system of claim 1, wherein the port selector is configured to automatically detect one or more of the plurality of video input ports that is active based on polling of the plurality of video input ports.

11. The system of claim 1, wherein the port selector is configured to provide a notification of the one or more of the plurality of video input ports that is providing video signals to the video output port.

12. The system of claim 1, wherein the port selector is configured to provide an audio signal about the one or more of the plurality of input ports that is providing video signals to the video output port.

13. The system of claim 1, further comprising a switching mechanism that at least one of determines or receives data about one or more of the plurality of video input ports that is providing video signals to the video output port, wherein the switching mechanism is configured to assign one or more component to a pathway between the one or more of the plurality of video input ports and the video output port.

14. The system of claim 1, wherein a pathway between one or more of the plurality of video input ports and the video output port includes at least one of a decoder, scaler, converter, splitter or switch.

15. The system of claim 1, wherein the device is a medical imaging device.

16. The system of claim 1, wherein a pathway between one or more of the plurality of input ports and the output port includes at least one of:
a. BNC Analog: Device >SDI/BNC Cable >BNC to HDMI Converter >HDMI Cable >HDMI to USB Video Capture Card >USB Cable >Surface;
b. SDI Digital: Device >SDI/BNC Cable >SDI to USB Video Capture Card >USB Cable >Surface;
c. HDMI: Device >HDMI Cable >HDMI to USB Video Capture Card >USB Cable >Surface;
d. DVI-D: Device >DVI to HDMI Cable >HDMI to USB Video Capture Card >USB Cable >Surface;
e. DVI-I: Device >DVI to HDMI Cable >HDMI to USB Video Capture Card >USB Cable >Surface;
f. DisplayPort: Device >DisplayPort to HDMI Cable >HDMI to USB Video Capture Card >USB Cable >Surface;
g. S-Video: Device >S-Video Cable >S-Video to HDMI Converter >HDMI Cable >HDMI to USB Video Capture Card >USB Cable >Surface;
h. VGA: Device >VGA Cable >VGA to HDMI Converter >HDMI Cable >HDMI to USB Video Capture Card >USB Cable >Surface;
i. BNC Analog Split: Device >SDI/BNC Input on Powered Splitter (plugged into outlet)>SDI/BNC Out to Device >SDI/BNC Out >BNC to HDMI Converter >HDMI Cable >HDMI to USB Video Capture Card >USB Cable >Surface;
j. SDI Digital Split: Device >SDI/BNC Input on Powered Splitter (plugged into outlet)>SDI/BNC Out to Device >SDI/BNC Out >BNC to HDMI Converter >HDMI Cable >HDMI to USB Video Capture Card >USB Cable >Surface;
k. HDMI Split: Device >HDMI Input on Powered Splitter (plugged into outlet)>HDMI Out 2 to Device >HDMI Out 1 to HDMI >HDMI to USB Video Capture Card >USB Cable >Surface;
l. DVI-D Split: Device >DVI Input on Powered Splitter (plugged into outlet)>DVI Out 2 to Device >DVI Out 1 to HDMI >HDMI to USB Video Capture Card >USB Cable >Surface;
m. DVI-I Split: Device >DVI Input on Powered Splitter (plugged into outlet)>DVI Out 2 to Device >DVI Out 1 to HDMI >HDMI to USB Video Capture Card >USB Cable >Surface;
n. S-Video Split: Device >S-Video (Male) into Device >S-Video (Female1) to original S-Video connection >S-Video (Female2) - S-Video Cable to HDMI >S-Video to HDMI Converter >HDMI Cable >HDMI to USB Video Capture Card >USB Cable >Surface; or
o. VGA Split: Device >VGA Input on Powered Splitter (plugged into outlet)>VGA Out to Device >VGA Out to VGA >VGA to HDMI Converter >HDMI Cable >HDMI to USB Video Capture Card >USB Cable >Surface.

17. A method comprising:
receiving, by one of a plurality of video input ports, a connection of a video output port of a device to the one of the plurality of video input ports, wherein at least some of the plurality of video input ports are of different types, and wherein each of the plurality of video input ports is configured for interfacing with a video output port of the device;
detecting, by a port selector, one or more of the plurality of video input ports that is receiving video signals;
activating, by the port selector, a display corresponding to the one or more of the plurality of video input ports that is receiving video signals;
receiving, by a video output port, the video signals;
receiving, by the video output port, a connection to a video input port of a video streaming device; and
receiving, by the input port of the video streaming device, the video signals from the video output port.
